(19) United States
(12) Patent Application Publication
(10) Pub. No.: US 2005/0135855 A1
(43) Pub. Date: Jun. 23, 2005

(54) Printing apparatus having function of scanner

(76) Inventors: Sang-cheol Park, Suwon-si (KR); Byung-sun Ahn, Suwon-si (KR); Young-min Kim, Suwon-si (KR); Won-mo Cho, Suwon-si (KR)

Correspondence Address: STANZIONE & KIM, LLP, 1740 N STREET, N.W., FIRST FLOOR, WASHINGTON, DC, 20036, US

(21) Appl. No.: 10/992,771

(22) Filed: Nov. 22, 2004

(30) Foreign Application Priority Data
Dec. 17, 2003 (KR) 2003-92507
Jun. 24, 2004 (KR) 2004-47645

(51) Int. Cl. G03G 15/00

(52) U.S. Cl. 399/405

(57) ABSTRACT

A printing apparatus includes a printing unit to print an image onto a recording sheet; a discharged sheet stacker positioned on the printing unit, in which sheets discharged from the printing unit are stacked; and a scanning unit positioned at the upper side of the discharged sheet stacker and moved from a first position to a second position to enlarge a stacking height of the discharged sheet stacker.

### CROSS-REFERENCE TO RELATED APPLICATIONS

This application claims the priorities of Korean Patent Application Nos. 2003-92507, filed on Dec. 17, 2003 and 2004-47645, filed on Jun. 24, 2004, in the Korean Intellectual Property Office, the disclosures of which are incorporated herein in their entirety and by reference.

### BACKGROUND OF THE INVENTION

1. Field of the Invention

The present general inventive concept relates to a printing apparatus, and more particularly, to a printing apparatus having an image reading function (a scanner function) and an image reproducing function (a printing function).

2. Description of the Related Art

A printing apparatus may have at least one additional function, such as a scanner function, capable of reading image information, a copying function, a facsimile function, or the like in addition to a principal printing function. In this case, although the apparatus may be called a combined printing apparatus, the apparatus will be called a printing apparatus hereinafter since the name of the combined printing apparatus is not clearly defined yet. A printing apparatus having a printing unit and a scanning unit basically has functions of a printer, a scanner, and a copier. Since the scanning unit can function as an input portion of a facsimile and the printing unit can function as an output portion of the facsimile, the printing apparatus can have a function of the facsimile when further comprising a line control unit (LCU).

Since such a printing apparatus has the printing unit and the scanning unit, the size thereof is relatively great. Since, until now, the printing apparatus has been mainly used in an office, there is almost no need to be concerned about the size of the printing apparatus. Recently, the printing apparatus tends to be used for personal use, and therefore the necessity of downsizing the printing apparatus is increasing. When the printing apparatus is used for personal use, it is necessary to reduce the footprint of the printing apparatus as much as possible, and it is also necessary to make the operation space thereof be within the footprint.

### SUMMARY OF THE INVENTION

Accordingly, the present general inventive concept provides a printing apparatus having a scanner function, which is improved so that a small footprint and a small operation space can be realized.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a printing apparatus including: a printing unit to print an image onto a recording sheet; a discharged sheet stacker positioned on the printing unit, in which sheets discharged from the printing unit may be stacked; and a scanning unit positioned at the upper side of the discharged sheet stacker and moveable from a first position to a second position to enlarge a stacking height of the discharged sheet stacker.

When the scanning unit is positioned at the first position, the stacking height of the discharged sheet stacker may be set to be 30 mm or less.

The printing apparatus may further comprise a sheet feed unit in which recording sheets to be supplied to the printing unit may be stacked, and the stacking height of the discharged sheet stacker may be greater than a maximum sheet stacking capacity of the sheet feed unit when the scanning unit is positioned at the second position.

The printing apparatus may further comprise a locking unit to lock the scanning unit at the second position.

The printing unit may discharge a recording sheet from a first end portion to a second end portion thereof in a lengthwise direction, and the scanning unit may be installed to be pivoted with respect to the printing unit, and the pivot center of the scanning unit may be positioned adjacent to the first end portion. The scanning unit may have a plurality of pivot positions, and the locking unit may be configured to lock the scanning unit at one of the plurality of pivot positions.

The printing unit may discharge a recording sheet from a first end portion to a second end portion in a lengthwise direction, and the scanning unit may be supported by an ascending and descending device positioned adjacent to the first end portion and may be installed to ascend and descend in a vertical direction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a structural diagram illustrating a printing apparatus according to an embodiment of the present general inventive concept;

FIG. 2 is a front view illustrating the printing apparatus of FIG. 1;

FIG. 3 is a structural diagram illustrating the printing apparatus of FIG. 1 in a state in which a scanning unit is pivoted;

FIG. 4 is a front view illustrating the printing apparatus of FIG. 1 in a state in which the scanning unit is pivoted;

FIG. 5 is a structural diagram illustrating an embodiment of a locking unit;

FIG. 6 is a section view illustrating an operation of the locking unit of FIG. 5;

FIG. 7 is a structural diagram illustrating another embodiment of a locking unit;

FIG. 8 is a section view illustrating an operation of the locking unit of FIG. 7;

FIGS. 9 and 10 are respectively an exploded perspective view and an engaged perspective view illustrating a printing apparatus according to another embodiment of the present general inventive concept; and

FIG. 11 is a perspective view illustrating the printing apparatus of FIGS. 9 and 10 in a state in which the scanning unit is positioned at a second position.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

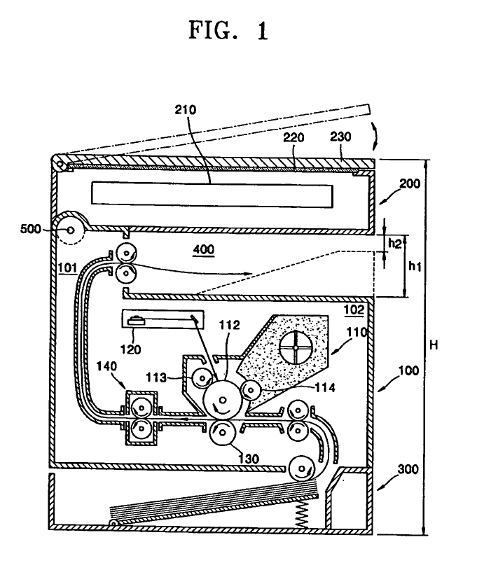

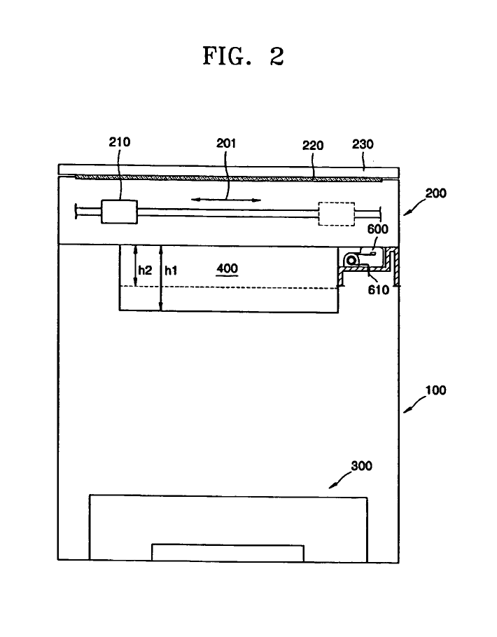

FIG. 1 is a structural diagram illustrating a printing apparatus according to an embodiment of the present general inventive concept, and FIG. 2 is a front view of the printing apparatus of FIG. 1.

Referring to FIGS. 1 and 2, a printing unit 100 to print an image on a recording sheet and a scanning unit 200 to read image information are shown.

The printing unit 100 may print an image by using an electro-photographic method. Referring to FIG. 1, a developing device 110, an exposure device 120, a transfer device 130, and a fixing device 140 are also shown. A photosensitive drum 112, a charging device 113, and a developing roller 114 may be integrated into the developing device 110. The charging device 113 uniformly charges a surface of the photosensitive drum 112 to a predetermined potential. The exposure device 120 scans the photosensitive drum 112 with light corresponding to image information. Then, an electrostatic latent image is formed on the surface of the photosensitive drum 112 according to potential differences between portions scanned and not scanned. The developing roller 114 forms a toner image by supplying toner onto the electrostatic latent image. A recording sheet fed from a sheet feeding unit 300 is moved between the photosensitive drum 112 and the transfer device 130. A transfer bias is then applied to the transfer device 130. The toner image is then separated from the surface of the photosensitive drum 112 and is attached to the recording sheet due to the transfer bias. The fixing device 140 may then apply heat and pressure to the toner image to cause the toner image to be fused and fixed onto the recording sheet. The printing unit 100 is not limited to the electro-photographic printing unit described, and may be applied to various printing units such as an inkjet printing unit, a thermal transfer printing unit, and the like.

The scanning unit 200 may have a reading unit 210 to read image information by illuminating light on a document sheet and detecting reflected light. A contact image sensor (CIS), a charge coupled device (CCD), or the like may be used as the reading unit 210. The scanning unit 200 may be a flat bed type scanning unit in which the reading unit 210 may be moved to read a document sheet. Reference numeral 220 denotes a document sheet bed 220 which is made of a transparent material and on which a document sheet is laid. Reference numeral 230 denotes a cover to cover the document sheet bed 220. The reading unit 210 may read image information from the document sheet while moving in the directions of arrow 201 of FIG. 2. The scanning unit 200 is not limited to a flat bed type one, and may be a sheet feed type one in which the reading unit 210 may be fixedly installed, and the document may be moved.

In order to reduce a footprint of the printing apparatus, the scanning unit 200 is positioned at the upper side of the printing unit 100. Reference numeral 400 denotes a discharged sheet stacker in which sheets discharged from the printing unit 100 may be stacked. The discharged sheet stacker 400 is positioned between the printing unit 100 and the scanning unit 200 so that a space required for an operation of the printing apparatus can be limited within the footprint of the printing apparatus. The sheet feeding unit 300 in which the recording sheets to be fed to the printing unit 100 may be stacked may be installed at the lower side of the printing unit 100.

With the above configuration, a recording sheet which may be fed from the sheet feeding unit 300 to the printing unit 100 and on a surface of which an image is printed may be discharged to the discharged sheet stacker 400. The printing unit 100 may discharge the printed sheet from a first end portion 101 to a second end portion 102 in a horizontal direction. The discharged sheet stacker 400 may be configured to have an ascending slope from the first end portion 101 to the second end portion 102, as shown in a dotted line in FIG. 1.

Since about 200˜250 recording sheets can be stacked in the sheet feeding unit 300, the discharged sheet stacker 400 requires a space having a height of at least about 30 mm so as to accommodate all of the sheets, and when taking into consideration a space required for a user to remove printed sheets, the height of the discharged sheet stacker 400 may need to be greater than 50 mm.

A stacking height of the discharged sheet stacker 400 is indicated by a height h1 or h2 between the scanning unit 200 and the printing unit 100. If the height h1 or h2 is designed to be relatively large, even though the stacking height can be greater, it may be disadvantageous to downsize the printing apparatus since the overall height H of the printing apparatus becomes greater. In contrast, if the height h1 or h2 is designed to be relatively small, it is advantageous to downsizing the printing apparatus since the overall height H of the printing apparatus becomes smaller, but if a sheet jam occurs during sheet discharge, it may be very difficult to remove the jammed sheet. In addition, aside from a standard sheet having a predetermined standard length, it may not be easy for the user to remove a small sheet, such as a postal card, having a short length from the discharged sheet stacker 400.

In the printing apparatus of this embodiment, the height h1 or h2 (FIG. 1) between the scanning unit 200 and the printing unit 100 may be set to be 30 mm or less. In addition, taking into consideration a facility of removing the jammed sheet and users' conveniences that may be necessary when a small sheet is printed, the printing apparatus is characterized in that the scanning unit 200 can be moved from a first position to a second position where the stacking height of the discharged sheet stacker 400 is enlarged. The scanning unit 200 may be able to ascend and descend in a vertical direction, or pivot on the first end portion 101 which can be a pivot center.

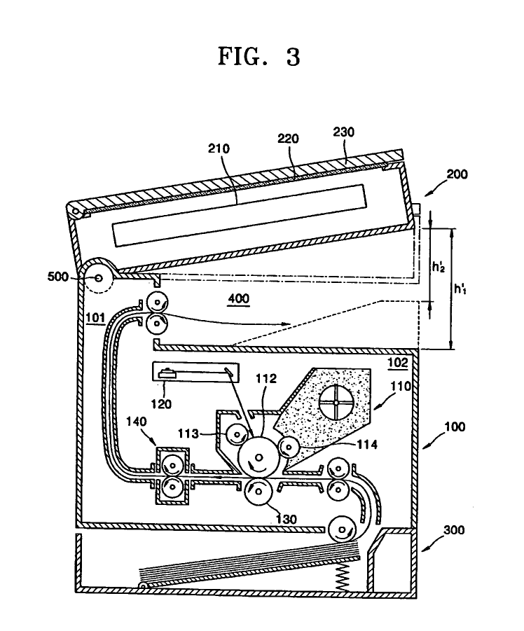

The scanning unit 200 can be installed to be able to pivot on a hinge 500, which can be a pivot center, from the first position shown in FIG. 1 and the second position shown in FIG. 3. The hinge 500 may be positioned at a side of the first end portion 101 of the printing unit 100. When the scanning unit 200 is positioned at the second position, the scanning unit 200 is moved far from the printing unit 100, and the stacking height of the discharged sheet stacker 400 becomes h1′ (or h2′). The stacking height h1′ or h2′ of the discharged sheet stacker 400 may be the same as or greater than a maximum stacking capacity of the sheet feeding unit 300 when the scanning unit 200 is positioned at the second position.

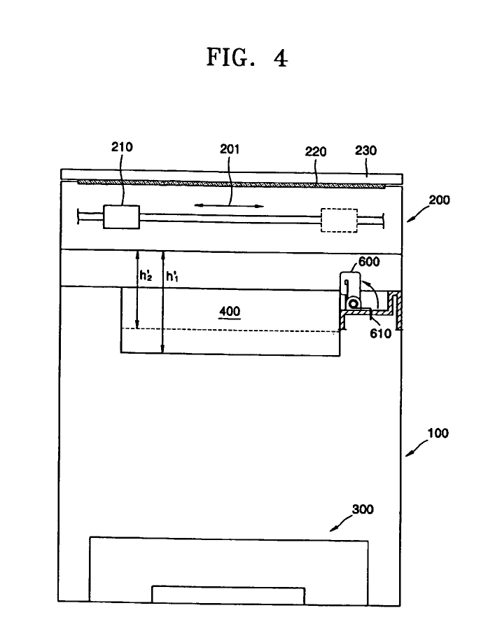

The printing apparatus of this embodiment may further comprise a locking unit to temporarily fix the scanning unit 200 at a pivoted position. The locking unit may include a support member 600 (See FIG. 2). The support member 600 may be pivoted at a third position (see FIG. 2) to support the scanning unit 200 when the scanning unit 200 is positioned at the first position, and at a fourth position (see FIG. 4) to support the scanning unit 200 when the scanning unit 200 is positioned at the second position. The support member 600 may be installed at any one or both side portions of the discharged sheet stacker 400. The locking unit may further include an elastic element 610 to apply an elastic force in a direction where the support member 600 is pivoted at the fourth position. With the above-described configuration, when the scanning unit 200 is pivoted at the second position, the support member 600 may be pivoted at the fourth position by an elastic force of the elastic member 610 to support the scanning unit 200. When the scanning unit 200 is returned to the first position, the support member 600 may be pushed and is returned to the third position. Then, as shown in FIG. 2, the scanning unit 200 may be supported by the support member 600 at the first position.

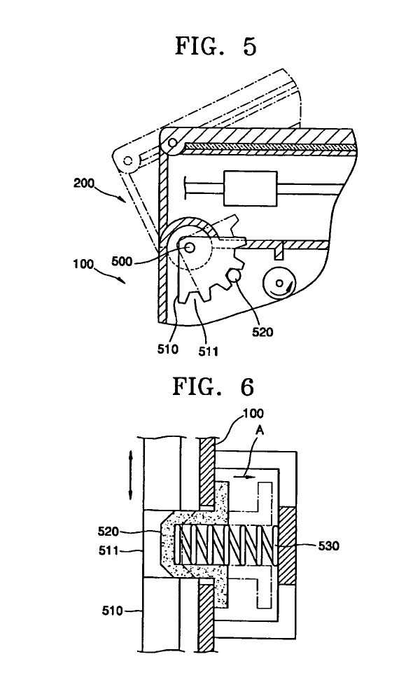

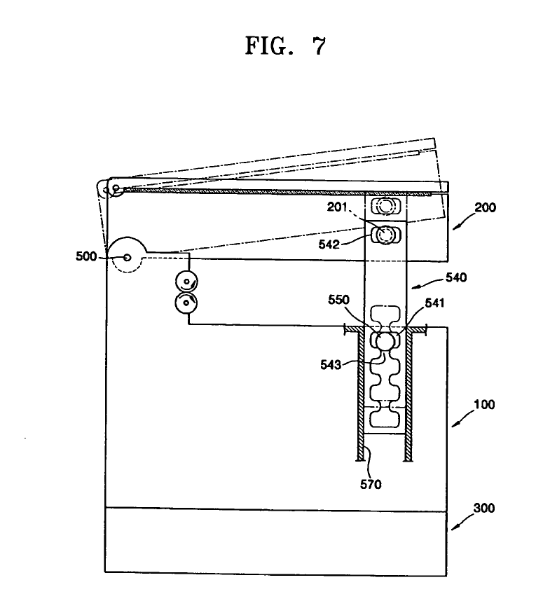

The scanning unit 200 may have a plurality of pivoted positions, and the locking unit may be configured so as to lock the scanning unit 200 at each of the plurality of pivoted positions, respectively. FIG. 5 is a structural diagram schematically illustrating a locking unit according to an embodiment of the present general inventive concept, and FIG. 6 is a section view illustrating an operation of the locking unit of FIG. 5.

Referring to FIG. 5, a first member 510 having a plurality of engagement grooves 511 may be joined to the scanning unit 200. The plurality of engagement grooves 511 may be provided on an arc being concentric with the hinge 500. A second member 520 to be elastically engaged with any one of the engagement grooves 511 may be joined to the printing unit 100. Referring to FIG. 6, the second member 520 may be supported by an elastic member 530 in a direction in which the second member 520 can be caused to engage with any one of the engagement grooves 511. The elastic force of the elastic member 530 may be set to be able to bear a rotational moment due to a weight of the scanning unit 200. Therefore, as long as the user does not pivot the scanning unit 200, the second member 520 will be maintained in a state in which the second member 520 is inserted in one of the engagement grooves 511. When the user pivots the scanning unit 200, the second member 520 may be pushed by the first member 510 according to a pivoting force of the user in a direction of arrow A of FIG. 6, and may be again engaged with one of the engagement grooves 511 by the elastic force of the elastic member 530. With the above-described configuration, the scanning unit 200 can be locked at a desired pivot position.

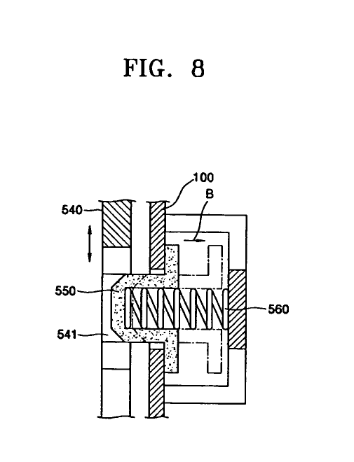

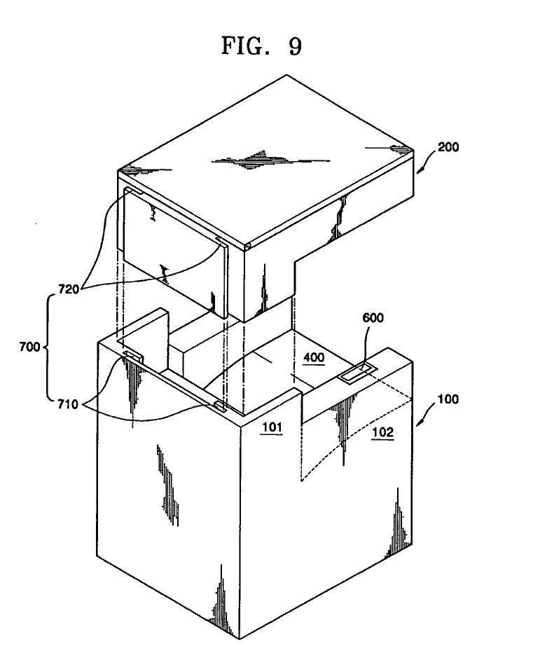

FIG. 7 is a structural diagram illustrating a locking unit according to another embodiment of the present general inventive concept, and FIG. 8 is a section view illustrating an operation of the locking unit of FIG. 7.

Referring to FIG. 7, a first member 540 having a plurality of engagement grooves 541 arranged in a vertical direction may be joined to the scanning unit 200. A guide rail 570 to guide the vertical movement of the first member 540 and a second member 550 to be elastically engaged with one of the plurality of engagement grooves 541 may be provided at the printing unit 100. As shown in FIG. 8, the second member 550 may be elastically supported by an elastic member 560 in a direction in which the second member 550 is caused to engage with one of the engagement grooves 541. An elastic force of the elastic member 560 may be set to be able to bear a rotational moment due to the weight of the scanning unit 200. Therefore, as long as the user does not pivot the scanning unit 200, the second member 550 may be maintained in a state in which the second member 550 is inserted in one of the engagement grooves 541. The locking unit may be configured so that the first member 540 can move only in the vertical direction when the scanning unit 200 is pivoted. To this end, as shown in FIG. 7, an engagement portion 542 having an elongated-horizontal-hole shape may be provided at the first member 540. A boss 201 which can be inserted into the engagement portion 542 may be provided at the scanning unit 200. When a user pivots the scanning unit 200, the second member 550 may be pushed by the first member 540 according to the pivoting force of the user in a direction of arrow B of FIG. 8 while passing through a bottle neck portion 543 of the first member 540, and will again be engaged with one of the engagement grooves 541 by the elastic force of the elastic member 560. With the above-described configuration, the scanning unit may be locked at a desired pivot position.

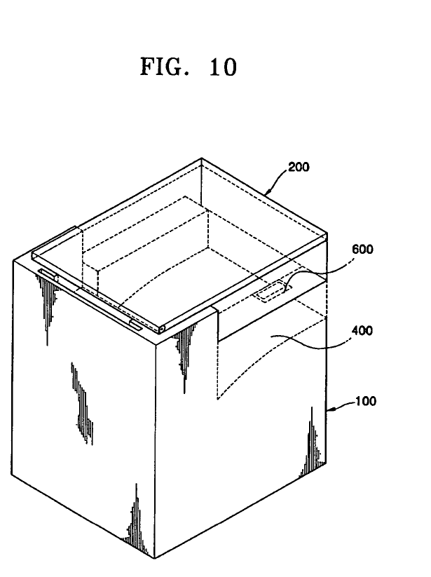

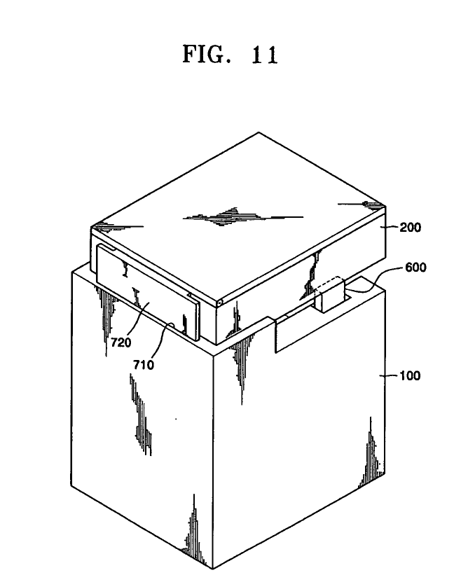

In order to enlarge the stacking height of the discharged sheet stacker 400, the scanning unit 200, according to an embodiment of the present general inventive concept, can ascend and descend in a vertical direction. As shown in FIG. 9, the printing apparatus may comprise an ascending and descending device 700. The ascending and descending device 700 may include a guide groove 710 and an insertion portion 720 inserted into the guide groove 710. The guide groove 710 may be positioned at the side of the first end portion 101 of the printing unit 100 and is formed in a vertical direction. The insertion portion 720 may be provided in the scanning unit 200. With the above-described configuration, the printing apparatus in which the scanning unit 200 ascends and descends in the vertical direction can be implemented. The support member 600 may be provided at the side portion of the discharged sheet stacker 400. The support member 600 may be the same as those shown in FIGS. 2 and 4. As shown in FIG. 10, when the scanning unit 200 is mounted in the printing unit 100, the scanning unit 200 may be supported by the support member 600. In order to enlarge the stacking height of the discharged sheet stacker 400, as shown in FIG. 11, the scanning unit 200 may be lifted upwards. Then, the support member 600 may be pivoted by the elastic element 610 (FIG. 2) at the fourth position to support the scanning unit 200.

With the above-described configuration, the space required for the operation of the printing apparatus can be within the footprint of the printing apparatus by disposing the discharged sheet stacker 400 between the scanning unit 200 and the printing unit 100. In addition, since the overall height H of the printing apparatus can be reduced by minimizing the stacking height of the discharged sheet stacker 400, the printing apparatus can be downsized. When the user is going to take the printed sheets, and in particular small sheets such as postal cards, photographs, or the like, out of the discharged sheet stacker 400, the printed sheets can be taken out of the discharged sheet stacker 400 after the scanning unit 200 is moved to the second position. Further, if a sheet jam occurs while a printed sheet is being discharged, the jammed sheet can be removed after the scanning unit 200 is moved to the second position.

As described above, with the printing apparatus having a function of a scanner according to the present general inventive concept, it is possible to realize a downsized printing apparatus which has a scanner function and a small footprint by configuring the printing apparatus to have a changeable stacking height of a discharged sheet stacker.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A printing apparatus comprising:
a printing unit to print an image onto a recording sheet;
a discharged sheet stacker positioned on the printing unit, in which sheets discharged from the printing unit are stacked; and
a scanning unit positioned at an upper side of the discharged sheet stacker and movable from a first position to a second position to enlarge a stacking height of the discharged sheet stacker.

2. The printing apparatus according to claim 1, wherein when the scanning unit is positioned at the first position, the stacking height of the discharged sheet stacker is set to be 30 mm or less.

3. The printing apparatus according to claim 1, further comprising a sheet feed unit in which recording sheets to be supplied to the printing unit are stacked, wherein the stacking height of the discharged sheet stacker is greater than a maximum sheet stacking capacity of the sheet feed unit when the scanning unit is positioned at the second position.

4. The printing apparatus according to claim 1, wherein the printing unit discharges a recording sheet from a first end portion to a second end portion thereof in a lengthwise direction, and the discharged sheet stacker is configured to have an ascending slope from the first end portion to the second end portion.

5. The printing apparatus according to claim 1, further comprising a locking unit to lock the scanning unit at the second position.

6. The printing apparatus according to claim 5, wherein the printing unit discharges a recording sheet from a first end portion to a second end portion in a lengthwise direction, and the scanning unit is installed to be pivoted with respect to the printing unit, and the pivot center of the scanning unit is positioned adjacent to the first end portion.

7. The printing apparatus according to claim 6, wherein the locking unit includes a support member that pivots to a third position to support the scanning unit when the scanning unit is positioned at the first position and to a fourth position to support the scanning unit when the scanning unit is positioned at the second position.

8. The printing apparatus according to claim 7, wherein the locking unit further includes an elastic member applying an elastic force in a direction where the support member is pivoted at the fourth position.

9. The printing apparatus according to claim 7, wherein the support member is installed at at least one of two side portions of the discharged sheet stacker.

10. The printing apparatus according to claim 6, wherein the scanning unit has a plurality of pivot positions, and the locking unit is configured to lock the scanning unit at each of the plurality of pivot positions.

11. The printing apparatus according to claim 10, wherein the locking unit includes:
a first member having a plurality of engagement grooves arranged on an arc having the pivot center of the scanning unit as a center; and
a second member to be elastically engaged with any one of the plurality of engagement grooves,
wherein the first member is joined to one of the printing unit and the scanning unit, and the second member is joined the other one thereof, so that the second member can be elastically engaged with one of the engagement grooves as the scanning unit is pivoted.

12. The printing apparatus according to claim 10, wherein the locking unit includes:
a first member which is joined to the scanning unit and has a plurality of engagement grooves arranged in a vertical direction; and
a second member installed at the printing unit so as to be elastically engaged with any one of the engagement grooves as the scanning unit is moved in a vertical direction.

13. The printing apparatus according to claim 5, wherein the printing unit discharges a recording sheet from a first end portion to a second end portion in a lengthwise direction, and the scanning unit is supported by an ascending and descending device positioned adjacent to the first end portion and is installed to ascend and descend in a vertical direction.

14. The printing apparatus according to claim 13, wherein the locking unit includes a support member that pivots to a third position to support the scanning unit when the scanning unit is positioned at the first position and to a fourth position to support the scanning unit when the scanning unit is positioned at the second position.

15. The printing apparatus according to claim 13, wherein the locking unit further includes an elastic member applying an elastic force in a direction where the support member is pivoted at the fourth position.

16. The printing apparatus according to claim 14, wherein the support member is installed at at least one of two side portions of the discharged sheet stacker.

17. A printing apparatus comprising:
an image forming unit to form an image;
an image reading unit formed on an upper side of the image forming unit to be moved toward and away from the image forming unit to create a gap of a variable size between the image forming unit and the image reading unit; and
a paper output tray formed in the gap to store paper output from the image forming device.

18. The printing apparatus according to claim 17, further comprising a locking unit to lock the image reading unit at a position where the size of the gap is largest.

19. The printing apparatus according to claim 17, further comprising a locking unit to lock the image reading unit at a plurality of positions to provide a plurality of sizes of the gap.

20. A printing apparatus comprising:
a printing unit to form and print an image; and
an adjustable scanning unit formed above the printing unit to adjust a position thereof relative to an upper surface of the printing unit,
wherein the upper surface of the printing unit provides a discharge sheet stacker in which sheets images printed thereon can be stacked.
